(19) United States
(12) Patent Application Publication
(10) Pub. No.: US 2013/0029792 A1
(43) Pub. Date: Jan. 31, 2013

(54) LACROSSE STICK WITH REINFORCED INTERCONNECTION BETWEEN HANDLE AND HEAD

(71) Applicants: Anthony Abdelmalek, Baltimore, MD (US); Jonathan Bond, Newton, MA (US)

(72) Inventors: Anthony Abdelmalek, Baltimore, MD (US); Jonathan Bond, Newton, MA (US)

(21) Appl. No.: 13/561,640

(22) Filed: Jul. 30, 2012

Related U.S. Application Data
(60) Provisional application No. 61/512,639, filed on Jul. 28, 2011.

(51) Int. Cl. A63B 59/02; F16B 1/00

(52) U.S. Cl. 473/513; 403/361

(57) ABSTRACT

A lacrosse stick with an elongate tubular handle, a plastic head and an improved connection assembly between the handle and head, the connection assembly including an insert inside the handle and straddling at least two opposing walls, at least one screw threaded through the insert and through the opposing walls of the handle to compress the insert between the walls of said handle. The threaded engagement of the screw through the walls and insert sandwich the latter, maintaining a constant compressive force against the laterally enlarged heads and against the interior walls of the handle. This avoids loosening and/or dislodgement as a result of impact or vibration, and resists the threads of the screw stripping either the walls or the insert as a result of torque or other stress. A unitary sleeve insert, a one-piece straddle post embodiment, and a two-piece post embodiment are herein shown and described.

### CROSS-REFERENCE TO RELATED APPLICATION(S)

The present application derives priority from U.S. provisional application serial no. 61/512,639 filed 28 Jul. 2011.

### BACKGROUND OF THE INVENTION

1. Field of the Invention

The present invention relates to lacrosse and, more particularly, to an improved connection between the handle and head of a lacrosse stick.

2. Description of the Background

In 1970, the introduction of double-wall, synthetic lacrosse heads revolutionized the game of lacrosse. In comparison to the traditional wooden single-wall heads, the synthetic heads imparted a lightness, maneuverability, and flexibility never-before experienced by lacrosse players. These performance advantages greatly enhanced players' skills such as throwing, catching, cradling, and scooping, and brought the sport of lacrosse to new levels of speed and excitement.

FIG. 1 illustrates a conventional molded head lacrosse stick. As shown, lacrosse stick 100 comprises a handle 102 shown in dotted lines, and a double-wall synthetic head 104. Head 104 comprises a generally V-shaped frame having a juncture 106, sidewalls 108 and 110, a transverse wall (or “scoop”) 112 joining the sidewalls at their ends opposite juncture 106, and a stop member 114 joining sidewalls 108 and 110 at their ends nearest juncture 106. As shown, handle 102 fits into and through juncture 106, and abuts stop member 114. A screw fastener placed through opening 107 secures handle 102 to head 104.

FIG. 2 illustrates a conventional injection molded goalie head comprising the same components as a field player's lacrosse stick illustrated in FIG. 1 but having a different overall shape due to its generally larger dimensions.

The typical features of a lacrosse stick are shown generally in Tucker et al., U.S. Pat. No. 3,507,495, Crawford et al., U.S. Pat. No. 4,034,984, and Tucker et al., U.S. Pat. No. 5,566,947, which are all incorporated by reference herein.

The traditional double-wall synthetic head is an injection-molded, monolithic structure. Examples of suitable synthetic materials well known in the art include nylon, polypropylene (PP), polyethylene (PE), amorphous polar plastics (e.g., polycarbonate (PC)), polymethylmethacrylate (PMMA), polystyrene (PS), high impact polystyrene (HIPS), polyphenylene oxide (PPO), glycol modified polyethylene terphthalate (PETG), acrylonitrile butadiene styrene (ABS), semicrystalline polar plastics (e.g., polyester PET and PBT), polyamide (e.g., Nylon 6 and Nylon 66), urethane, polyketone, polybutylene terephalate, acetals (e.g., Delrin™ by DuPont), acrylic, acrylic-styrene-acrylonitrile (ASA), metallocene ethylene-propylene-diene terpolymer (EPDM) (e.g., Nordel™ by DuPont), and composites. When first introduced, these materials were clearly superior to wood, offering players improved handling and durability. For example, a lacrosse head constructed of DuPont™ ZYTEL ST 801 nylon resin is able to withstand the bending and harsh impacts inherent to competition far better than a traditional wooden stick. As another example, polycarbonate, though having a flexibility similar to wood, is more structurally durable than wood and much lighter and, therefore, easier to handle.

Ever since the plastic head was incorporated on competition lacrosse sticks in the 1970s the plastic head has been attached to the handle with a simple screw connection, e.g., a “self-tapping” screw through the plastic head and handle (self-tapping screws cut their own threads).

The durability of that connection has long been an issue for several reasons. Repeatedly removing and re-assembling the components will eventually strip the hole and prevent stable assembly. In addition, the stresses on competition lacrosse sticks during play weakens the conventional connection inevitably to the point where the head sometimes loosens or even dislodges from the handle during play. Loosening/dislodgement can occur as the screw unscrews as a result of vibration, or as a result of the threads of the screw stripping as a result of torque or other stress, as no other forces are brought to bear to prevent these occurrences. The problem is growing acute due to the increasing use of lighter and thinner handles. The thread engagement is often limited to two or fewer threads, which cause extreme stress and instability of the head/handle connection which causes stripping and loosening of the head/handle. For example, when the handle encounters an impact, the walls can compress or expand and, without other internal securing mechanisms, easily strip the screw threads. Modern players often resort to taping over the head/handle connection when they feel the connection loosening from play. Moreover, like all athletes lacrosse players are growing bigger and stronger, pressures on the screw connection are increasing, and what is needed is a more robust interconnection for the handle and head of a lacrosse stick to avoid loosening/dislodgement.

References in this application to “competitive play”, “competitive sticks” and the like refer to lacrosse games and sticks that are subject to a governing body set of rules and regulations, such as the NCAA for men's lacrosse, US Lacrosse for women's lacrosse, the National Federation of State High School Association for much of high school lacrosse and variations adopted by individual private school and recreational leagues. Such terms do not refer to articles that have some or all of the basic components of lacrosse sticks (e.g. STX “Fiddle STX”) but which due to their overall size, durability, etc. are not intended for use in competitive play.

### SUMMARY OF THE INVENTION

It is, therefore, an object of the invention to provide a robust connection mechanism for the handle and head of a lacrosse stick that employs an integral threading mechanism capable of expansion to provide a stronger interconnection, avoid loosening/dislodgement, and which can accommodate various inner handle dimensions.

In accordance with the foregoing objects, the present invention is the combination of an elongate tubular lacrosse handle, a plastic head and an improved connection assembly between the handle and head. In a preferred embodiment, the connection mechanism comprises a collar insert compression-fitted inside the handle. The insert has a compressible body portion which, in an uncompressed form conforms to the interior walls of the handle and is defined by front, back and lateral sides. The insert is anchored inside the handle by detent flanges protruding on the opposing lateral sides of the insert. In addition, the insert has at least one screw threaded through the body portion from top-to-bottom, the screw engaging said body portion so as to compress it inside said handle.

In another embodiment, the connection assembly comprises a unitary one-piece straddle post inserted into the hollow interior of the handle. The straddle post comprises a generally-cylindrically shaped body with internally-threaded through-bore, and a head at both ends of the body, the heads being laterally enlarged with respect to the body and intended for abutment against the interior walls of the handle. This alternative embodiment also comprises a machine screw threaded through at least a first wall of the lacrosse handle and through the straddle post. The machine screw can optionally be threaded through a second opposing wall of the lacrosse handle. The threaded engagement of the screw through the wall(s) and straddle post sandwich the latter, maintaining a constant compressive force against the laterally enlarged heads and against the interior walls of the handle. This avoids loosening and/or dislodgement as a result of impact or vibration, and resists the threads of the screw from stripping either the wall(s) or the insert as a result of torque or other stress.

In yet another embodiment the interconnection comprises a two-piece nut and bolt system where the nut piece comprises a generally cylindrically-shaped body with internally threaded through bore, and a non-cylindrical head at its external end, the head being laterally enlarged and non-cylindrical to prevent the nut piece from spinning when engaged. The nut piece is inserted through a first wall of the plastic head and a first wall of a lacrosse handle. The alternative embodiment also comprises a shoulder bolt piece comprising a generally cylindrical body with external threads along its distal end and a head at the opposing end, the head being laterally enlarged with respect to the body and intended for abutment against the exterior wall of the lacrosse head. The shoulder bolt piece is inserted through a second opposing wall of the plastic head and the second opposing wall of the lacrosse handle (which is inserted into the head). The threaded engagement of the shoulder bolt piece and the nut piece maintains a constant compression force against the external walls of the plastic head and, in turn, the external walls of the handle. The shoulder bolt piece is also sized to create a friction fit between the interior wall of the head and the exterior wall of the handle, providing lateral support to the interconnection and thereby better securing the head.

All embodiments avoid loosening and/or dislodgement as a result of impact or vibration, and resist the threads of the conventional screw stripping either the walls or the insert as a result of torque or other stress. Further, the forces brought to bear by the compression of the plastic head on the handle is in addition to the secure fit of the head and handle caused by the above-described attachment mechanisms serve to prevent unwanted movement and provides a more secure engagement.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front view of a conventional lacrosse stick with handle 102 inserted in molded plastic head 104, and conventional (prior art) screw fastener placed through opening 107 securing handle 102 to head 104.

FIG. 2 illustrates a conventional injection molded goalie head incorporating the same prior art components as the field player's lacrosse stick illustrated in FIG. 1, albeit with a different overall shape due to its generally larger dimensions.

FIG. 3 is a side perspective view of a lacrosse stick with reinforced interconnection 12 between handle and head according to an embodiment of the invention.

FIG. 4 is a side perspective view of the reinforced interconnection 12 of FIG. 3.

FIG. 5 is a top view of the reinforced interconnection 12 of FIGS. 3-4.

FIG. 6 is an end view of the reinforced interconnection 12 of FIGS. 3-5.

FIG. 7 is a side view of the reinforced interconnection 12 of FIGS. 3-6.

FIG. 8 is a perspective view of a lacrosse stick with reinforced interconnection between handle and head according to an alternate embodiment of the invention, with enlarged insets of the straddle post and screw used therein.

FIG. 9 is a sequential assembly drawing illustrating the method for assembling the lacrosse stick with reinforced interconnection between handle and head as in FIG. 8.

FIG. 10 is an exploded perspective view of a lacrosse stick with reinforced interconnection between handle and head according to a third embodiment of the invention.

FIG. 11 is a perspective view of the lacrosse stick with reinforced interconnection as in FIG. 10.

FIG. 12 is a cross-section of the lacrosse stick with reinforced interconnection as in FIGS. 10-11.

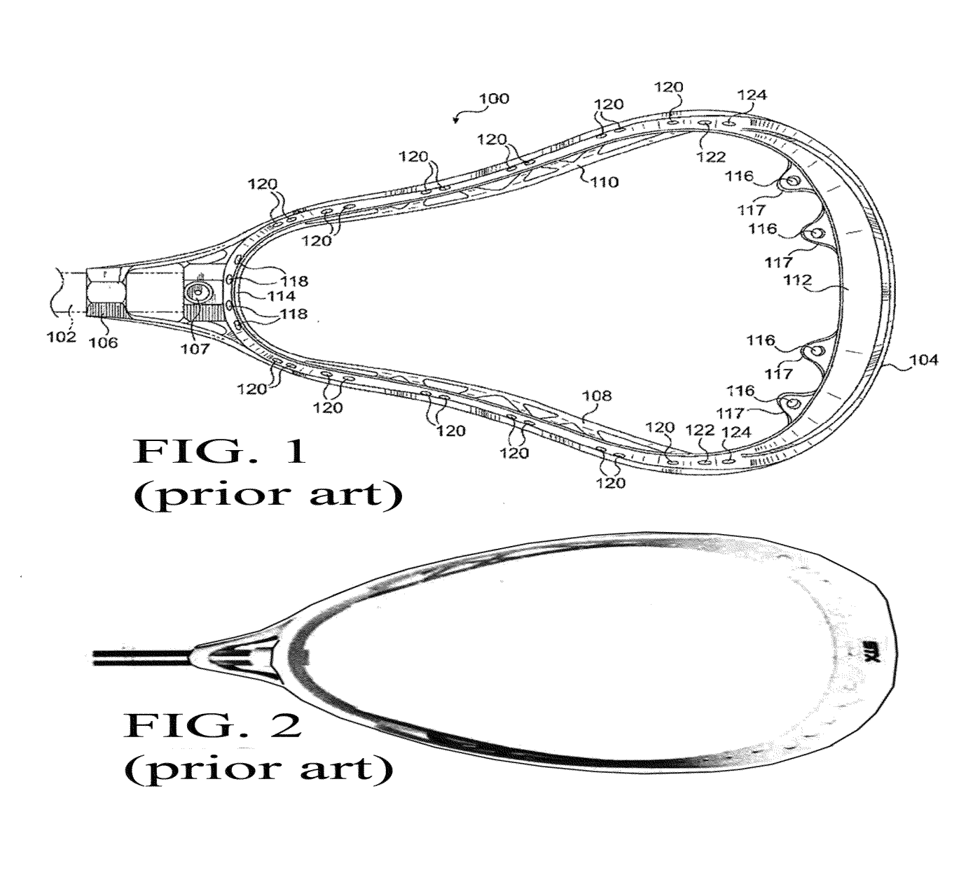

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is the combination of an elongate tubular lacrosse handle, a plastic head having a frame with a socket for insertion of the handle, and an improved connection assembly between the handle and head. In one embodiment the connection assembly comprises a collar insert fitted into the hollow end of the handle. At least one and preferably two screws are threaded sidelong through the wall of the handle and into threaded apertures in the collar insert. This sandwiches the handle wall to collar insert. Moreover, the collar insert deforms inside the handle and the deformation forms a compression fit which avoids loosening and/or dislodgement as a result of impact or vibration, and further resists the threads of the screw stripping either the walls or the insert as a result of torque or other stress. Alternate embodiments including a one-piece straddle post and a two-piece straddle post are also shown and described.

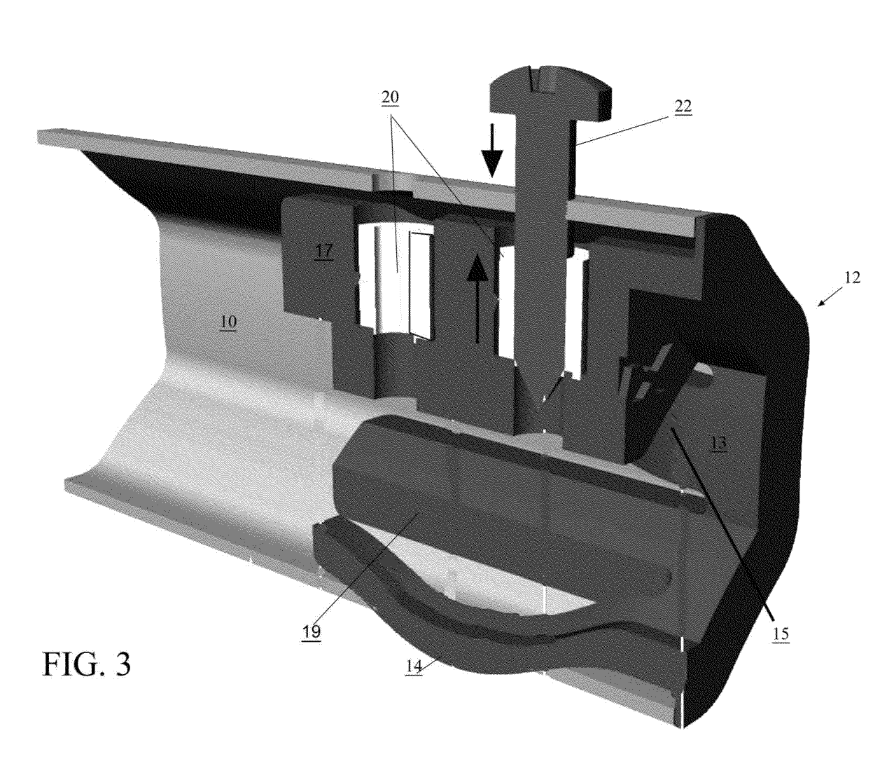

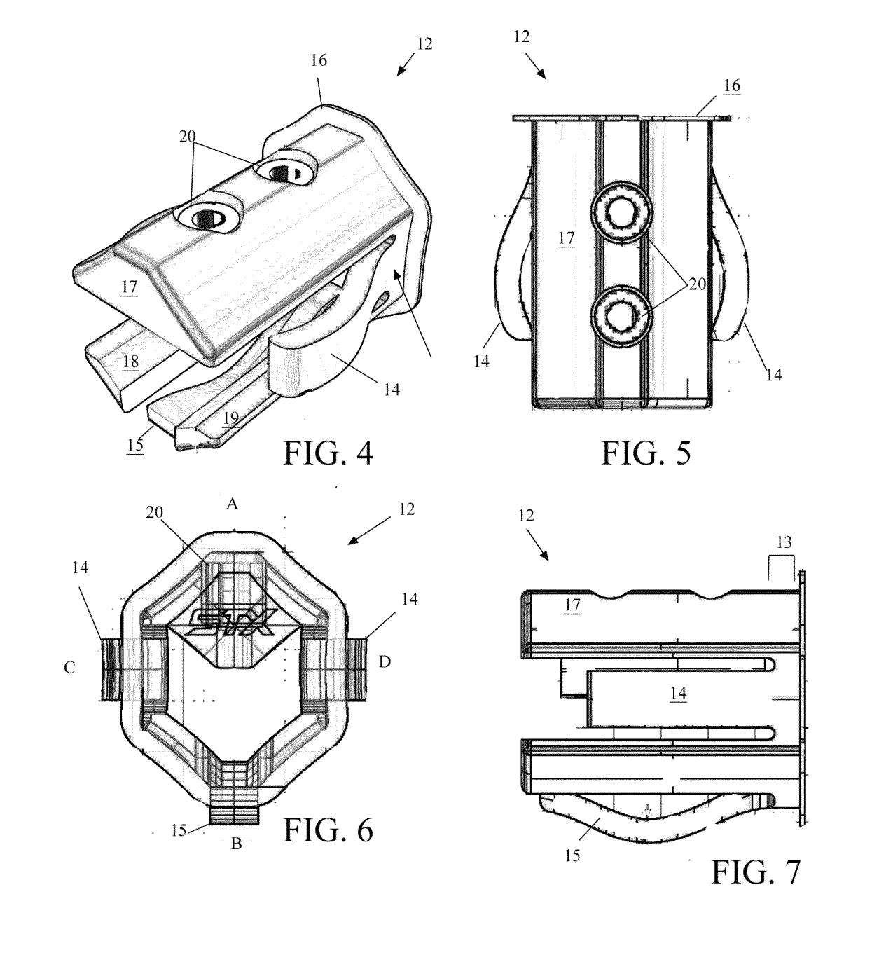

FIG. 3 is a side perspective sectional view of a lacrosse stick with reinforced interconnection 12 between handle 10 and head according to an embodiment of the invention. The elongate tubular lacrosse handle 10 may be any conventional tubular lacrosse handle such as a traditional hexagonal cross-section formed of aluminum or composite. The plastic head (not shown) likewise has a traditional basket-frame with a socket at one end for insertion of the handle 10. The lacrosse handle 10 is fixedly attached inside the socket of the head by an improved connection assembly that straddles the opposing walls of the handle 10. FIGS. 4-7 are side perspective, top, end and side views, respectively, of the improved connection assembly. With collective reference to FIGS. 3-7 the reinforced interconnection generally comprises a unitary plastic insert having a body portion 12 and reinforcing collar 13. The body portion 12 is insertable into an end of the handle 10 and may be secured therein, positioning the reinforcing collar 13 inside the distal lip of the handle 10 for interior reinforcement when the handle 10 is inserted into the head (as will be described). Body portion 12 is deformable, and in its normal form generally conforms to the interior walls of the handle 10. As seen in FIG. 6 the body portion 12 is defined by top (A), bottom (B) and lateral sides (C, D). The body portion 12 is anchored inside the handle 10 by a plurality of detent flanges 14, 15 that resiliently protrude from the sides of the insert. In this case two opposing detent flanges 14 protrude from the lateral sides (C, D) of the insert, and one 15 from the bottom (B). The reinforcing collar 13 is encircled by a flange 16 at one end to limit insertion into handle 10. In the illustrated embodiment three stationary prongs protrude axially from body portion 12, including a larger substantially trapezoidal prong 17 at top and two smaller spaced prongs 18, 19 at bottom. The plurality of detent flanges 14, 15 protrude axially between the prongs 17-19, attached (integrally molded) to flange 16, and remain free at their outer distal tip for resilience. As best seen in FIG. 5, the detent flanges 14, 15 are formed with an outward elbow and/or are pre-biased outward so as to engage the inner walls of the handle 10. Given the spacing and angular orientation of the flat surfaces of the detent flanges 14, 15 against the inner walls of handle 10, the pre-load exerted thereby against the typically octagonal inner walls compresses when the body portion 12 is inserted into the handle 10, and self-center it. Additionally, if desired, the pronounced elbows of detent prongs 14, 15 may provide a snap-fit interlock into cooperating notches or windows formed in the walls of the handle 10.

Referring back to FIG. 3, the large trapezoidal prong 17 atop the body portion 12 is a hollow-molded part formed with at least one and preferably two molded sleeves or through-bores passing there through from top to bottom. Preferably two self-clinching nuts 20 are overmolded or otherwise seated in the sleeves/through-bores and serve as screw-anchors, and two screws 22 are threaded into the clinch nuts 20 through holes in the walls of handle 10, although a single self-clinching nut 20/screw 22 combination may be used. As seen by the arrows of FIG. 3, as the screw(s) 22 are tightened within the self-clinching nuts 20 (down arrow) the nut(s) 20 themselves are pulled upward within the stationary prong 17 against the inner topwall of the handle 19 (up arrow). When fully inserted and tightened the handle 10 wall becomes sandwiched between the self-clinching nuts 20 and head of screw(s) 22, thereby securing the insert body 12 within the walls of handle 10. If desired, the screws 22 may be extended to engage the lower detent prong 15 and/or lower stationary prongs 18, 19 and bias it/them outward against the handle 10. The combination of a threaded engagement of the screws 22 through handle walls 10 and through inserts 20 in body portion 12, plus the compressive force of the screws 22 biasing the stationary prong 17 against the body portion 12 effectively provides a more stable reinforcing collar inside the handle 10 along the distal tip that is inserted into the head. This helps to avoid loosening and/or dislodgement as a result of impact or vibration, and resists the threads of the screw stripping either the walls or the insert as a result of torque or other stress.

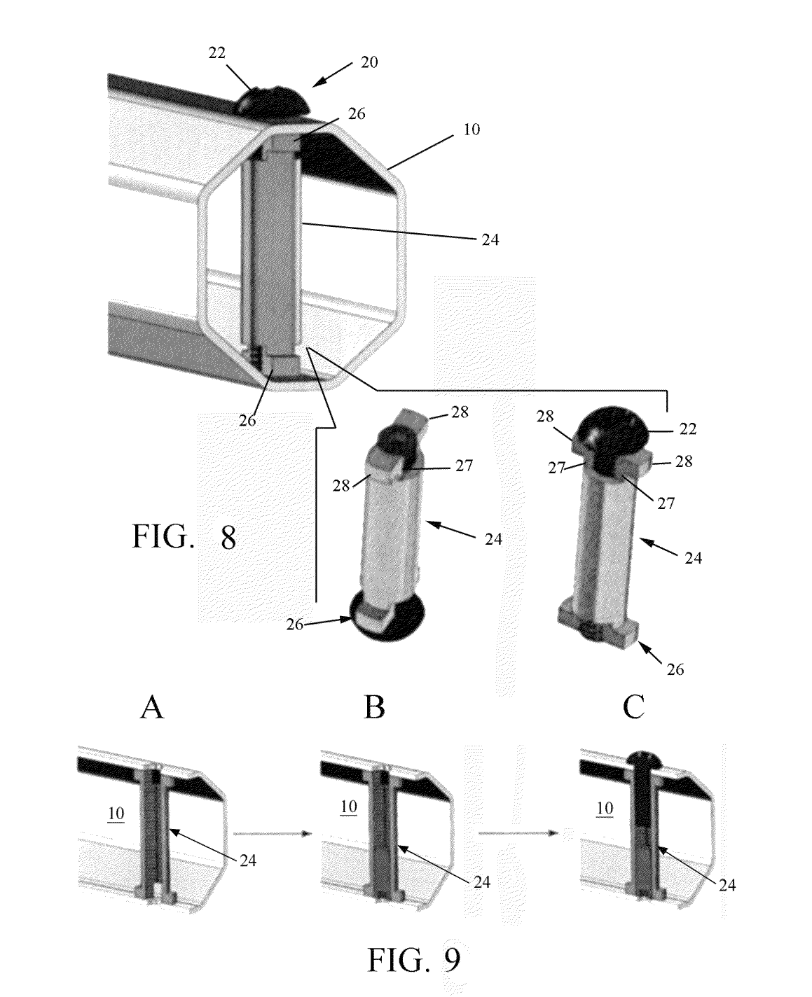

FIG. 8 is a perspective view of a lacrosse stick with reinforced interconnection between handle and head according to another embodiment of the invention, with enlarged insets of the insert nut and screw used therein. Again the lacrosse handle 10 is fixedly attached inside the socket of the head by an improved connection assembly 20, this one straddling the opposing walls of the handle 10. The connection assembly 20 further comprises an insert nut 24 inserted into the hollow interior of the handle 10, and a machine screw 22 threaded through at least one side of the plastic head socket/handle 10 and through a substantial portion of the length of the insert nut 24. A single machine screw 22 may be used, or two machine screws threaded into opposing sides of the inset nut 24. If a single machine screw is used, it is preferably (but optionally) threaded through all the walls of the plastic head socket/handle 10, as well as the entire connection assembly 20. The connection assembly 20 is far more robust than a self-tapping screw and avoids loosening and/or dislodgement as a result of impact or vibration, or stripping of the threads (in the handle walls or insert nut) as a result of torque or other stress.

The machine screw 22 is a conventional machine screw of a length calculated to extend through the desired length of the insert nut 24. If a single machine screw 22 is used its length may exactly equal the diameter of the socket at the end of handle 10. Said length may be halved where two machine screws 22 are threaded into opposing sides of the inset nut 24.

The insert nut 24 comprises a generally cylindrical-shaped body with internally-threaded through-bore, and a head 26 at both ends of the body. The heads 26 may assume any of a variety of configurations all being laterally enlarged with respect to the body, and thereby adapted for abutment against the interior walls of the handle 10. In the illustrated embodiment, the heads 26 each comprise a pair of opposing legs 27 extending co-axially from the body, and a pair of feet 28 each extending diagonally from a corresponding leg 27.

FIG. 9 is a sequential assembly drawing illustrating the method for assembling the lacrosse stick with reinforced interconnection between handle and head as in FIG. 8.

Initially, the lacrosse handle 10 should be inserted inside the socket of the head.

As shown at (A), the nut insert 24 is placed inside the handle 10 with its through-bore in axial alignment with both mounting holes (as conventionally provided on commercial lacrosse stick handles). At (B), the user inserts the machine screw 22 through one wall of the socket of the head, and begins to thread it through the underlying wall of the handle 10 and through the insert nut 24 using an appropriate implement such as an Allen wrench may be used to tighten the machine screw 22. At (C), tightening continues through the opposing wall of the handle, and through the other wall of the socket of the head 10, optionally applying a hex nut as an anchor. This secures the head to the handle 10. The threaded engagement of the screw 22 through the walls and insert nut 24 sandwich the latter, maintaining a constant compressive force against the laterally enlarged heads 26 and against the interior walls of the handle 10. This avoids loosening and/or dislodgement as a result of impact or vibration, and resists the threads of the screw stripping either the walls or the insert as a result of torque or other stress.

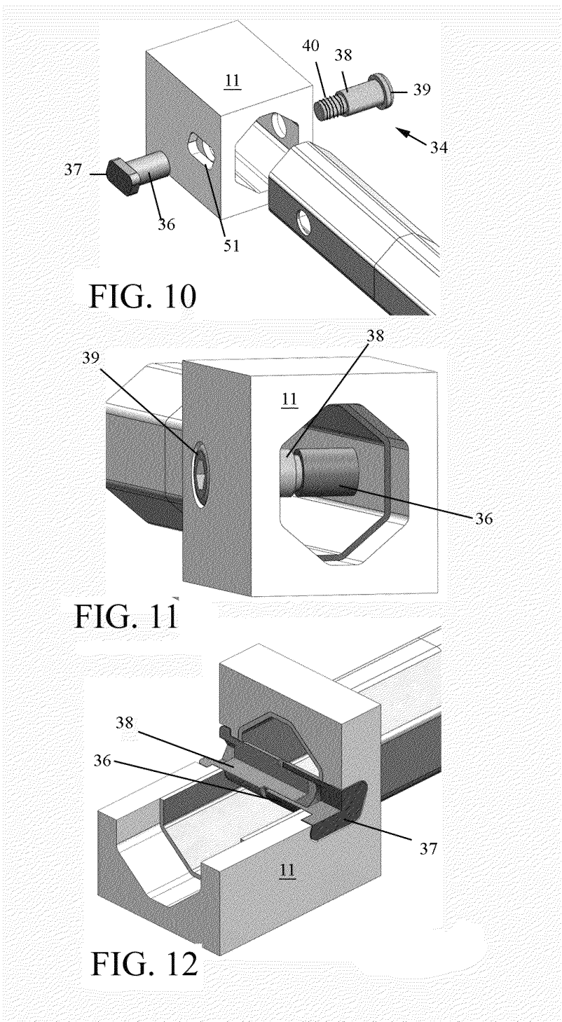

FIG. 10 is an exploded perspective view of a lacrosse stick with reinforced interconnection between handle and head according to a third embodiment of the invention, in which the insert nut is a two-piece embodiment. Here the insert nut 34 comprises two generally-cylindrically-shaped body sections 36, 38 each having a head 37, 39 at one end. If desired, one head 37 may be non-circular, keyed to a corresponding receptacle 51 in the plastic collar 11 of the lacrosse head (not shown). The other head 39 is an enlarged circular flange with keyed recess (e.g., hex, Phillips, flathead or the like) for tightening the opposing halves of the two-piece insert nut 34 together.

The distal end of one body section 38 comprises an externally-threaded male fitting 40 for insertion into a corresponding internally-threaded receptacle in the distal end of the other body section 36.

FIG. 11 is a perspective view of the attached body sections 36, 38, and FIG. 12 is a cross-section of the lacrosse stick with reinforced interconnection as in FIGS. 10.

When the opposing halves of the two-piece insert nut 34 are screwed together and tightened, the compressive force likewise solves both stripping and loosening problems.

It should now be apparent that the above-described invention provides a more robust interconnection for the handle and head of a lacrosse stick because the threaded engagement of the screw 10 through the walls and insert nut 24 (or like engagement of the two-piece insert nut) 34 sandwich the walls, maintaining a constant compressive force against the laterally enlarged heads and against the interior walls of the handle. This avoids loosening and/or dislodgement as a result of impact or vibration, and resists the threads of the screw stripping either the walls or the insert as a result of torque or other stress.

Those skilled in the art will understand that various modifications and variations can be made in the present invention without departing from the spirit or scope of the invention. It is to be understood, therefore, that the invention may be practiced otherwise than as specifically set forth in the appended claims.

What is claimed is:

1. An interconnection mechanism for a lacrosse stick comprising an elongate tubular handle, and a head attached to said handle, said head having a frame with a socket for insertion of said handle, said interconnection mechanism fixedly attaching said handle within the socket of said head, and further comprising an insert inserted axially inside said handle and abutting at least two opposing walls of the handle, and at least one screw threaded into said insert and through a wall of said handle, and tightened to compress said insert within the walls of said handle.

2. The interconnection mechanism according to claim 1, wherein said insert body comprises a flange at one end.

3. The interconnection mechanism according to claim 1, further comprising a self-clinching nut seated in said insert body for anchoring said at least one screw.

4. The interconnection mechanism according to claim 1, wherein said insert comprises an internally-threaded post straddling opposing walls of said handle.

5. The interconnection mechanism according to claim 1, wherein said post comprises two mating sections.

6. The interconnection mechanism according to claim 1, further comprising a pair of self-clinching nuts seated in said insert body, said at least one screw comprising a pair of screws each anchored in one of said pair of self-clinching nuts.

7. The interconnection mechanism according to claim 1, wherein said insert body comprises at least one stationary prong extending axially inside said handle and at least one resilient prong extending axially inside said handle parallel and adjacent to said stationary prong.

8. The interconnection mechanism according to claim 7, wherein said resilient prong comprises an elbow.

9. The interconnection mechanism according to claim 8, wherein said handle comprises a notch formed therein for snap-fit insertion of the elbow of said resilient prong.

10. The interconnection mechanism according to claim 3, wherein said self-clinching nut slides within said insert body as said screw is tightened to sandwich a wall of said handle.

11. A lacrosse stick comprising:
an elongate tubular handle having a width;
a head attached to said handle, said head having a frame with a socket for insertion of said handle;
an interconnection mechanism for fixedly attaching said handle within the socket of said head, said interconnection mechanism further comprising a sleeve insert fitted inside said handle and conforming to an inner surface of said handle, said sleeve insert having at least one stationary prong extending axially inside said handle and at least one resilient prong extending axially inside said handle adjacent said stationary prong, said resilient prong having an unbiased position exceeding a width of said handle; and
at least one screw threaded through a wall of said handle and into said insert body.

12. The lacrosse stick according to claim 11, wherein said insert body comprises a flange for limiting insertion into said handle.

13. The lacrosse stick according to claim 11, further comprising a self-clinching nut seated in said insert body for anchoring said at least one screw.

14. The lacrosse stick according to claim 13, further comprising a pair of self-clinching nuts seated in said insert body, said at least one screw comprising a pair of screws each anchored in one of said pair of self-clinching nuts.

15. The lacrosse stick according to claim 14, wherein said pair of self-clinching nuts slide within said insert body as said screws are tightened to sandwich a wall of said handle.

16. The lacrosse stick according to claim 11, wherein said stationary prong has a substantially trapezoidal cross-section.

17. The lacrosse stick according to claim 16, wherein said resilient prong comprises an elbow.

18. The lacrosse stick according to claim 17, wherein said handle comprises a notch formed therein for snap-fit insertion of the elbow of said resilient prong.

19. An interconnection mechanism for fixedly attaching a lacrosse stock handle within a socket of a lacrosse head, said interconnection mechanism further comprising:
an insert body inserted inside said handle, said insert body conforming to an inner surface of said handle, and at least one resilient prong having an unbiased position in which it protrudes beyond a width of said handle; and
at least one screw threaded through said handle into said insert body to secure said insert body against the inner surface of said handle.

20. The interconnection mechanism according to claim 19, wherein said insert body comprises a flange for limiting insertion into said handle.

21. The interconnection mechanism according to claim 19, wherein said at least one screw is threaded through said handle and through said insert body and abuts said prong to bias said prong against the inner surface of said handle.

22. The interconnection mechanism according to claim 19, further comprising a self-clinching nut seated in said insert body for anchoring said at least one screw.

23. The interconnection mechanism according to claim 22, further comprising a pair of self-clinching nuts seated in said insert body, said at least one screw comprising a pair of screws, said pair of self-clinching nuts for anchoring said pair of screws.

24. The interconnection mechanism according to claim 19, wherein said insert body comprises a stationary prong protruding axially inside said handle adjacent said resilient prong.

25. The interconnection mechanism according to claim 19, wherein said resilient prong comprises an elbow.

26. The interconnection mechanism according to claim 25, wherein said handle comprises a notch formed therein for snap-fit insertion of the elbow of said resilient prong.
